(19) United States
(12) Patent Application Publication
(10) Pub. No.: US 2013/0303152 A1
(43) Pub. Date: Nov. 14, 2013

(54) METHOD AND APPARATUS FOR REQUESTING INTER-CELL INTERFERENCE COORDINATION AND METHOD AND APPARATUS FOR PROCESSING INTER-CELL INTERFERENCE COORDINATION REQUEST

(71) Applicants: Si Hyung Kim, Seoul (KR); Ki Bum Kwon, Seoul (KR)

(72) Inventors: Si Hyung Kim, Seoul (KR); Ki Bum Kwon, Seoul (KR)

(73) Assignee: Pantech Co., Ltd., Mapo-su, Seoul (KR)

(21) Appl. No.: 13/977,105

(22) PCT Filed: Dec. 28, 2011
(86) PCT No.: PCT/KR2011/010227

§ 371 Date: Jun. 28, 2013

(30) Foreign Application Priority Data
Dec. 30, 2010 (KR) 10-2010-0139378

(51) Int. Cl. H04W 16/14

(52) U.S. Cl. CPC H04W 16/14
USPC 455/422.1

(57) ABSTRACT

The present invention relates to a method and apparatus in which UE of an RRC_IDLE state which is near a femto cell (i.e., a Closed Subscriber Group (CSG) cell), but is not a CSG member requests a Base Station (BS) of a femto cell to apply Inter-Cell Interference Coordination (ICIC). In the present invention, the UE of an RRC_IDLE state selects a femto cell having a CSG ID not included in an allowed CSG list, transmits a Tracking Area Update (TAU) request message to a Mobility Management Entity (MME) managing the BS through the BS. Here, the TAU request message is a transfer request message requesting that a request to apply the ICIC be transferred to the BS of the CSG femto cell.

### CROSS-REFERENCE TO RELATED APPLICATIONS

This application is the National Stage Entry of International Application PCT/KR2011/010227, filed on Dec. 28, 2011, and claims priority from and the benefit of Korean Patent Application No. 10-2010-0139378, filed on Dec. 30, 2010, both of which are incorporated herein by reference in their entireties for all purposes as if fully set forth herein.

### BACKGROUND

1. Field

The present invention relates to wireless communication technology, and more particularly, to an apparatus and method for coordinating inter-cell interference.

2. Discussion of the Background

In the 3GPP release 8 of 3^{rd} Generation Partnership Project (3GPP) Long Term Evolution (LTE) that is an improvement of a Universal Mobile Telecommunications System (UMTS), Orthogonal Frequency Division Multiple Access (OFDMA) is used in downlink, Single Carrier-Frequency Division Multiple Access (SC-FDMA) is used in uplink, and Multiple Input Multiple Output (MIMO) having a maximum of four antennas is adopted. 3GPP LTE-Advanced (LTE-A) that is an evolution of 3GPP LTE is recently being in progress.

With the development of wireless communication technology, a heterogeneous network environment is being on the rise.

In the heterogeneous network environment, a micro cell, such as a femto cell, is used along with a macro cell. The micro cell is a system covering a smaller area than the existing mobile communication service radius in comparison with the macro cell.

In this communication system, a user terminal placed in any one cell experiences inter-cell interference that causes signal interference resulting from a signal generated from another cell.

### SUMMARY

It is an object of the present invention to provide a method in which user equipment of an RRC_IDLE state which is near a femto cell (i.e., a Closed Subscriber Group (CSG) cell), but is not a CSG member requests a base station of a femto cell to apply Inter-Cell Interference Coordination (ICIC).

It is another object of the present invention to provide a method in which user equipment of an RRC_IDLE state which is not a CSG member requests a base station of a femto is cell (i.e., a CSG cell) to apply ICIC by using a Tracking Area Update (TAU) request message for a Mobility Management Entity (MME).

It is yet another object of the present invention to provide a method in which user equipment of an RRC_IDLE state can smoothly perform cell (re)selection or RRC connection setup or both by requesting a femto cell base station to apply ICIC.

The present invention relates to a method of User Equipment (UE) of an RRC_IDLE state requesting Inter-Cell Interference Coordination (ICIC), comprising the steps of selecting a Closed Subscriber Group (CSG) femto cell having a CSG Identity (ID) not included in an allowed CSG list and transmitting a Tracking Area Update (TAU) request message to a Mobility Management Entity (MME), managing a Base Station (BS), through the BS, wherein the TAU request message comprises a transfer request message requesting that a request to apply the ICIC be transferred to the BS of the CSG femto cell. Here, the CSG femto cell refers to a femto cell (i.e., a CSG cell).

The transfer request message may be a cause value indicating that the TAU request message is transmitted by selecting the CSG femto cell having the CSG ID not included in the allowed CSG list.

In the method of UE of an RRC_IDLE state requesting Inter-Cell Interference Coordination (ICIC), the ICIC may be the application of an Almost Blank Subframe (ABS) pattern.

The method of UE of an RRC_IDLE state requesting Inter-Cell Interference Coordination (ICIC) may further include the step of determining whether to perform manual cell selection or autonomous cell search. If the manual cell selection is determined to be performed, the steps from the step of selecting the CSG femto cell may be performed, and if the autonomous is cell search is determined to be performed, a message requesting to apply an ABS pattern may be directly transmitted to the CSG femto cell.

Here, the message requesting to apply the ABS pattern may be an interference stress message transmitted on a random access channel.

Furthermore, the present invention relates to a method of a Mobility Management Entity (MME) processing a request for Inter-Cell Interference Coordination (ICIC), comprising receiving a Tracking Area Update (TAU) request message, determining whether a transfer request message, requesting that a request to apply Inter-Cell Interference Coordination (ICIC) be transferred to a Base Station (BS) of a CSG femto cell, is included in the TAU request message, and if the transfer request message is determined to be included in the TAU request message, transmitting a request to apply the ICIC to the BS of the CSG femto cell.

If the TAU request message is determined to be a TAU request message received from User Equipment (UE) when the UE selects a CSG femto cell having a CSG ID not included in an allowed CSG list, the transfer request message may be determined to be included in the TAU request message.

Whether the TAU request message is the TAU request message received from the UE when the UE selects the CSG femto cell having the CSG ID not included in the allowed CSG list may be determined by checking a cause value for a TAU request.

If the target CSG femto cell is not the subject of management of an MME that receives the TAU request message, a message requesting that the request to apply the ICIC be transferred to the BS of the CSG femto cell may be transmitted to an MME managing the BS of the CSG femto cell.

According to the present invention, user equipment of an RRC_IDLE state which is near a femto cell (i.e., a CSG cell), but is not a CSG member can request a base station of a femto cell to apply Inter-Cell Interference Coordination (ICIC).

According to the present invention, user equipment of an RRC_IDLE state which is not a CSG member can request a base station of a femto cell (i.e., a CSG cell) to apply ICIC by using a TAU request message for an MME.

According to the present invention, user equipment of an RRC_IDLE state can smoothly perform cell (re)selection or RRC connection setup or both.

### BRIEF DESCRIPTION OF THE DRAWINGS

FIG. 1 is a block diagram showing a wireless communication system;

FIG. 2 is a block diagram showing a functional split between an E-UTRAN and an EPC;

FIG. 3 is a block diagram showing a radio protocol architecture for a user plane;

FIG. 4 is a block diagram showing a radio protocol architecture for a control plane;

FIG. 5 is a flowchart schematically illustrating a TAU procedure;

FIG. 6 is a schematic diagram illustrating a concept of a heterogeneous network consisting of a macro cell, a femto cell, and a pico cell;

FIG. 7 is a schematic conceptual diagram illustrating the configuration of a femto cell;

FIG. 8 is a schematic exemplary diagram of a network structure that operates an HNB using an HNB gateway;

FIG. 9 is a schematic diagram illustrating that a user terminal is affected by interference between a macro cell and a femto cell in downlink;

FIG. 10 is a schematic diagram showing an example of a pattern of downlink subframes of a macro cell and a femto cell;

FIG. 11 is a flowchart schematically illustrating an example in which UE requests a femto cell to apply an ABS pattern by manually performing cell selection in a system to which the present invention is applied;

FIG. 12 is a flowchart schematically illustrating another example in which UE requests a femto cell to apply an ABS pattern by manually performing cell selection in a system to which the present invention is applied;

FIG. 13 is a flowchart schematically illustrating a method in which UE requests a femto cell to apply an ABS pattern if the UE autonomously performs cell search in a system to which the present invention is applied;

FIG. 14 is a flowchart schematically illustrating a method in which UE of an RRC_IDLE state which is not a CSG member requests an ABS pattern from a femto cell (i.e., a CSG cell) in a system to which the present invention is applied;

FIG. 15 is a flowchart schematically illustrating an operation performed in an eNB in case of a TAU request according to manual CSG selection in a system to which the present invention is applied;

FIG. 16 is a flowchart schematically illustrating an operation performed in an MME in case of a TAU request according to manual CSG selection in a system to which the present invention is applied;

FIG. 17 is a flowchart schematically illustrating the operation of a femto cell BS that has been requested to apply an ABS pattern in a system to which the present invention is is applied; and

FIG. 18 is a schematic block diagram showing the constructions of execution entities in a system to which the present invention is applied.

### DETAILED DESCRIPTION OF THE ILLUSTRATED EMBODIMENTS

It is to be noted that in assigning reference numerals to respective constituent elements in the drawings, the same reference numerals designate the same constituent elements although the constituent elements are shown in different drawings. Furthermore, in describing embodiments of the present invention, a detailed description of the known functions and constructions will be omitted if it is deemed to make the gist of the present invention unnecessarily vague.

Furthermore, the present specification focuses on a wireless communication network. Tasks performed in the wireless communication network may be performed in a process of a system (e.g., a base station), controlling the wireless communication network, controlling the wireless communication network and transmitting data or may be performed in user equipment connected to the wireless communication network.

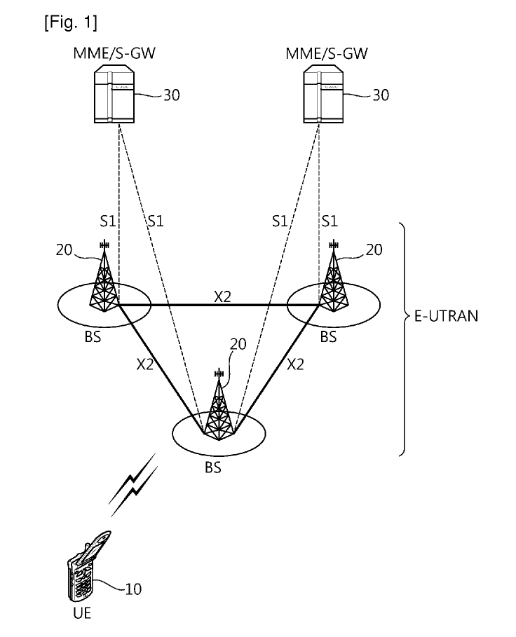

FIG. 1 is a block diagram showing a wireless communication system. The wireless communication system may be a network structure of 3GPP LTE/LTE-A. An Evolved-UMTS Terrestrial Radio Access Network (E-UTRAN) includes a Base Station (BS) 20 provides User Equipment (UE) with a control plane and a user plane.

The UE 10 may be fixed or mobile and may also be called another terminology, such as a Mobile Station (MS), a User Terminal (UT), a Subscriber Station (SS), a Mobile Terminal (MT), or a wireless device.

The BS 20 refers to a fixed station communicating with the UE 10, and it may also be called another terminology, such as an evolved-NodeB (eNB), a Base Transceiver System (BTS), or an access point.

One or more cells may exist in one BS 20. Here, the cell should be interpreted as a comprehensive meaning indicating some regions covered by the BS 11, and it has a meaning covering all various coverage areas, such as a mega cell, a macro cell, a micro cell, a pico cell, a femto cell, and a relay.

An interface for user traffic or control traffic transmission may be used between the BSs 20. The BSs 20 may be interconnected through an X2 interface.

The BS 20 is connected to an Evolved Packet Core (EPC) through an S1 interface, more particularly, a Mobility Management Entity (MME) through an S1-MME and to a Serving GateWay (S-GW) through an S1-U. The S1 interface supports a many-to-many relation between the BS 20 and an MME/SAE GW (S-GW) 30.

Hereinafter, downlink refers to communication from the BS 20 to the UE 10, and uplink refers to communication from the UE 11 to the BS 20. In downlink, a transmitter may be part of the BS 20, and a receiver may be part of the UE 10. Furthermore, in uplink, a transmitter may be part of the UE 10, and a receiver may be part of the BS 20.

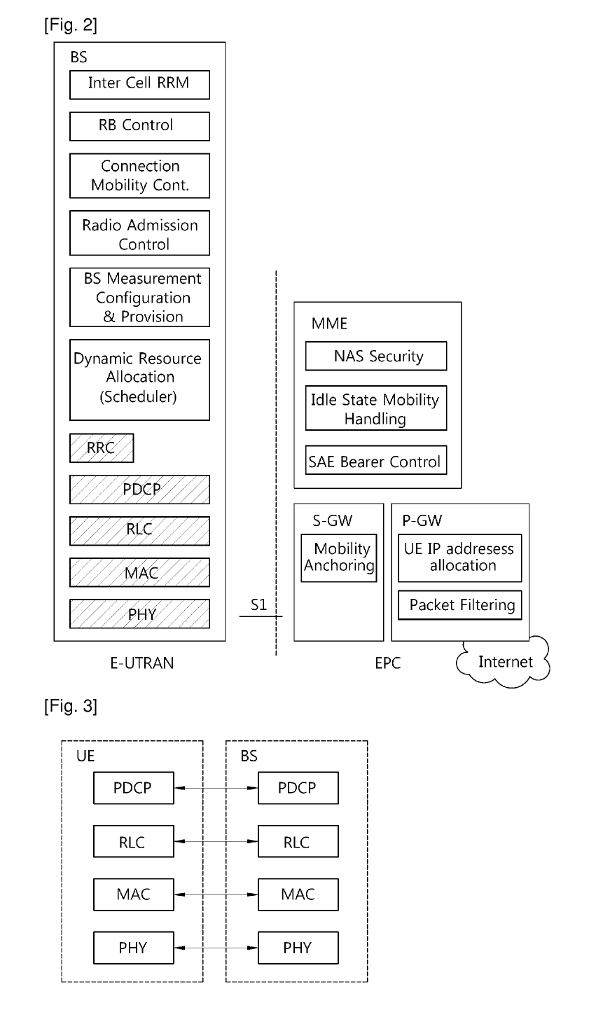

FIG. 2 is a block diagram showing a functional split between an E-UTRAN and an EPC. An LTE/LTE-A network system including the E-UTRAN (i.e., a wireless access network) forms an Evolved Packet System (EPS) along with a network structure that is a non-wireless aspect called a ‘System Architecture Evolution (SAE)’ including an Evolved Packet System (EPC) (i.e., a core network). Slash boxes indicate radio protocol layers, and white boxes indicate the functional entities of a control plane. The function of each functional entity is described below.

A BS performs the following functions: (1) A Radio Resource Management (RRM) function, such as radio bearer control, radio admission control, connection mobility control, and dynamic resource allocation to a UE, (2) The compression of an Internet Protocol (IP) header and the decryption of user data streams, (3) The routing of user plane data to an S-GW (serving gateway), (4) The scheduling and transmission of a paging message, (5) The scheduling and transmission of broadcast information, and (6) Measurement for mobility and scheduling and the setting of a measurement report.

The MME is a control node fro processing signaling between a UE and a core network. A protocol used between the UE and the core network is also called an NAS protocol. The MME commonly performs the following functions: (1) Non-Access Stratum (NAS) signaling, (2) NAS signaling security, (3) Idle mode UE reachability, (4) Tracking area list management, (5) Roaming, and (6) Authentication.

The S-GW is a user plane node, and it connects an Evolved Packet Core (EPC) (i.e., a core network) to an LTE Radio Access Network (RAN). User IP packets are transferred through the S-GW. The S-GW functions as a local mobility anchor for data bearers when UE moves between eNBs. The S-GW performs the following functions: (1) Mobility anchoring and (2) Lawful interception.

A PDN-GateWay (P-GW) is a gateway for connecting the user plane, connected to the EPC, to the Internet, and it performs the following functions.

(1) UE Internet Protocol (IP) allocation. (2) Packet filtering.

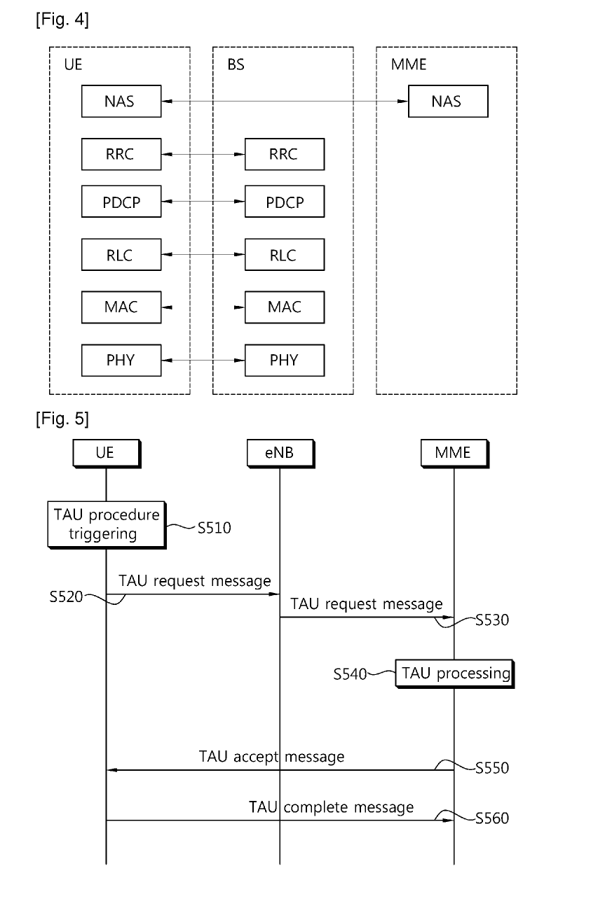

FIG. 3 is a block diagram showing a radio protocol architecture for the user plane. FIG. 4 is a block diagram showing a radio protocol architecture for the control plane. The data plane is a protocol stack for user data transmission, and the control plane is a protocol stack for control signal transmission.

Referring to FIGS. 3 and 4, a PHYsical layer (PHY) provides a higher layer with information transfer service by using a physical channel. The PHY is connected to a Medium Access Control (MAC) layer (i.e., a higher layer) through a transport channel.

Data is moved between the MAC layer and the PHY through the transport channel. The transport channel is classified according to how data is transmitted according to what characteristic through a wireless interface. 3GPP LTE/LTE-A includes the following transport channels.

A Broadcast Channel (BCH) has a transport format fixed according to a standard. The BCH is used to transmit some of pieces of Broadcast Control Channel (BCCH) system information, such as a Master Information Block (MIB).

A Paging Channel (PCH) is used to transmit paging information from a Paging Control Channel (PCCH) (i.e., a logical channel). The PCH may use discontinuous reception (DRX) so that UE can receive the PCH only in a predetermined time interval.

A Downlink Shared Channel (DL-SCH) is a main transport channel used in downlink data transmission.

A Multicast Channel (MCH) is used to support Multimedia Broadcast/Multicast Service (MBMS), and the MCH may use a semi-static transport format and scheduling.

An Uplink Shared Channel (UL-SCH) is a channel for uplink data transmission and may be said to be a channel corresponding to the DL-SCH.

A Random Access Channel (RACH) is a transport channel used in random access, but it does not transfer a transport block.

Meanwhile, data is moved between different PHYs (i.e., the PHYs of a transmitter and a receiver) through a physical channel. A PCCH may be used in the PHY.

A Physical Downlink Control Channel (PDCCH) informs UE of the resource allocation of a Paging Channel (PCH) and a Downlink Shared Channel (DL-SCH) and Hybrid Automatic Repeat reQuest (HARQ) information related to the DL-SCH. The PDCCH may carry an uplink scheduling grant that informs UE of the resource allocation of uplink transmission.

A Physical Downlink Shared Channel (PDSCH) is a main PHY for unicast transmission and may also be used for paging information transmission.

A Physical Control Format Indicator Channel (PCFICH) is a channel that provides information necessary to decode PDCCHs, such as informing UE of the number of OFDM symbols used in PDCCHs. The PCFICH is transmitted for every subframe.

A Physical Hybrid ARQ Indicator Channel (PHICH) carries HARQ ACK/NAK signals for uplink transmission.

A Physical Uplink Control Channel (PUCCH) carries uplink control information, such as HARQ ACK/NAK, a scheduling request, and a CQI for downlink transmission.

A Physical Uplink Shared Channel (PUSCH) carries an Uplink Shared Channel (UL-SCH). The PUSCH may be called a channel corresponding to the PDSCH.

A Physical Broadcast Channel (PBCH) transmits some of pieces of information which is necessary for UE to access a network.

A Physical Multicast Channel (PMCH) is used for a Multicast-Broadcast Single Frequency Network (MBSFN) operation, and a Physical Random Access Channel (PRACH) is used for random access.

The functions of the MAC layer include mapping between a logical channel and a transport channel and multiplexing/demultiplexing as a transport block which is provided to a physical channel on the transport channel of an MAC Service Data Unit (SDU) belonging to a logical channel.

The MAC layer provides service to a Radio Link Control (RLC) layer through a logical channel. The logical channel may be divided into a control channel for transferring control region information and a traffic channel for transferring user region information.

The functions of the RLC layer include the concatenation, segmentation, and reassembly of the RLC SDU.

In order to guarantee a variety of Quality of Services (QoS) requested by Radio Bearers (RB), the RLC layer provides three kinds of operating modes, including a Transparent Mode (TM), an Unacknowledged Mode (UM), and an Acknowledged Mode (AM). The AM RLC provides error correction through an Automatic Repeat reQuest (ARQ).

The functions of a Packet Data Convergence Protocol (PDCP) layer in the user plane include the transfer of user data, header compression, and ciphering. The functions of the PDCP layer in the user plane include the transfer of control plane data, ciphering, and integrity protection.

A Radio Resource Control (RRC) layer is defined only in the control plane. The RRC layer is related to the configuration, re-configuration, and release of radio bearers and is responsible for control of the logical channels, the transport channels, and the physical channels.

A Radio Bearer (RB) means a logical path provided by a first layer (PHY layer) and second layers (the MAC layer, the RLC layer, and the PDCP layer) for data transfer between UE and a network. To configure an RB means a process of defining the characteristics of a is radio protocol layer and a channel in order to provide specific service and configuring detailed parameters and an operating method.

The RB may be divided into two types; a Signaling RB (SRB) and a Data RB (DRB). The SRB is used as a passage that transmits an RRC message in the control plane, and the DRB is used a passage that transmits user data in the user plane.

A Non-Access Stratum (NAS) layer placed over the RRC layer performs functions, such as session management and mobility management.

An applicable procedure related to an Access Stratum (AS) varies according to a Radio Resource Control (RRC) state of UE. The RRC state relates to whether the RRC of UE has a logical connection with the RRC of an E-UTRAN. The RRC state is divided into an RRC_CONNECTED state and an RRC_IDLE state.

In the RRC_CONNECTED state, an E-UTRAN can check the existence of UE on a cell basis based on RRC connection between the UE and the E-UTRAN. Accordingly, the UE can be controlled on a cell basis.

In the RRC_IDLE state, an E-UTRAN cannot check the existence of UE because there is no RRC connection between the UE and the E-UTRAN. Accordingly, UE of an RRC-IDLE state is managed for every Tracking Area (hereinafter referred to as a ‘TA’) having a greater core network range than a cell. The TA is a set of contiguous cells that help to track UEs, and it corresponds to a zone where UE is paged. Each TA is identified by a Tracking Area Identity (TAI). The TAI is broadcasted through a wireless interface. If all the TAIs are configured within all the eNBs, the TAIs are automatically transferred to relevant MME nodes.

Accordingly, only the existence of UE is checked on a TA basis in the RRC_IDLE state. UE may perform normal communication over a network after switching to is the RRC_CONNECTED state. Here, the normal communication includes not only voice call, but also communication services, such as video telephony and data communication which may be used by a user over a network.

UE selects a cell where the UE may stay in the RRC_IDLE state, and the UE is prepared to receive service from the relevant cell. This process is called cell selection. When UE is on, the UE may select a cell, register its own information with a core network through a relevant cell, and stay in the RRC_IDLE state. When UE of the RRC_CONNECTED state is switched to the RRC_IDLE state, the UE selects a cell and stay in the RRC_IDLE state.

Cell selection includes an operation in which UE searches for a cell having a strong carrier frequency supported for Radio Access Technology (RAT). However, cell selection is performed by UE in the state in which the UE has not decided a cell where the UE will stay in the RRC_IDLE state. Long time should not be taken for cell selection. Accordingly, a cell providing wireless communication quality of a specific level or higher, although the cell does not provide the best quality, may be selected as a cell where UE may stay in the RRC_IDLE state.

The UE camps on the selected cell. While camping on the selected cell, the UE acquires system information broadcasted from the selected cell. Next, the UE may register its existence with a TA and receive paging information.

After cell selection, the UE may set up RRC connection and then, for example, perform a Tracking Area Update (TAU) or set up a call. Furthermore, after cell selection, the UE may perform cell reselection.

After the UE performs cell selection, a communication environment between the selected cell and the UE may be changed owing to the movement of the UE, a change of a is wireless environment, etc. If communication quality of the selected cell is deteriorated, the UE may reselect a cell providing better communication quality. This is called cell reselection. Unlike in cell selection, the main object of cell reselection is to select a cell providing the best communication quality. UE may take the order of priority for each frequency into consideration, along with communication quality of a cell in the cell reselection process.

As described above, UE of the RRC_IDLE state is managed on a TA basis. A BS may broadcast a change of system information, etc. through paging. The cell (re)selection procedure may also be called UE mobility in the RRC_IDLE state in contrast with a handover procedure regarding UE mobility in the RRC_CONNECTED state.

Meanwhile, if the UE selects a cell satisfying specific suitability and camps on the selected cell as described above, the UE receive broadcasted system information. If the UE moves to a cell belonging to another TA, the UE sets up a simple signaling access between the UE and an eNB in order to inform information about a position within the new TA before receiving paging information. A process of the UE updating TA information owing to various causes, including movement to another TA as described above, is called a Tracking Area Update (TAU).

UE registered with an MME (i.e., UE in an EMM registered state) may initiate the TAU procedure by sending a TAU request message to the MME. If the UE detects that it has entered a TA not existing in a list of TAs previously registered with the MME, if a periodic TA updating timer has expired, if the UE has received an indicator informing that RRC connection has been released for reason of a “load balancing TAU is required” from a lower layer, if the UE has changed UE network capability information, if the UE has changed a DRX parameter specific to the UE, if the UE has received an indicator informing an “RRC connection is failure” from a lower layer and there is no pending user uplink data, if the UE has selected a CSG having a CSG ID not included in the allowed CSG list of the UE through manual CSG selection, and so on, the UE may send the TAU request message to the MME.

FIG. 5 is a flowchart schematically illustrating the TAU procedure.

A UE performs triggering for starting the TAU procedure (S510). The UE may determine whether a case where a TAU has been requested has occurred as described above. If it is determined that a case where a TAU has been requested has occurred, the UE transmits a TAU request message to an eNB (S520). The UE may transmit the TAU request message to the eNB of a cell belonging to a current TA. The eNB transfers the received TAU request message to an MME (S530). The TAU request message is a message of a Non-Access Stratum (NAS) level. Thus, the eNB transparently transfers the TAU request message to the MME. In the TAU process, the MME for the UE may be changed. For example, if a TAU request is made because a TA has been changed, the MME may be changed according to a change of the TA. The TAU request message is transferred to the MME of the TA to which the UE now belongs (i.e., the MME now managing the eNB).

The MME receives the TAU request message and performs TAU processing (S540). The MME performs a procedure necessary for the TAU, such as updating a position in a Home Subscriber Server (HSS). For example, if an MME has been changed, a new MME that has received a TAU request message may receive context from an old MME and obtain information necessary for UE. Furthermore, the new MME may finish a session with an S-GW or a P-GW or both which are related to the old MME and set up a session with a new S-GW or a new P-GW or both.

The MME transfers a TAU accept message to the UE (S550). The TAU accept is message may include a new TAI list for the UE.

The UE that has received the TAU accept transfers a TAU complete message to the MME (S560).

Meanwhile, in the case where a TAU request message can be transmitted, a case where UE has selected a CSG having a CSG ID not belonging to the allowed CSG list of the UE through manual CSG selection (hereinafter referred to as ‘the case of a TAU request through manual CSG selection’) may occur in a heterogeneous network, including a femto cell (i.e., a CSG cell) and a non-CSG cell.

A heterogeneous network is described below.

As in the case where a femto cell or a pico cell or both exist within the coverage of a macro cell, heterogeneous cells exist within the same space in a heterogeneous network.

The use of the micro cell, such as a pico cell and a femto cell, is not specially limited, but the pico cell may be commonly used in a communication shadow region, not covered by only the macro cell, and an area requiring a lot of data service (so called a hot zone). In general, the femto cell may be used in indoor offices or homes.

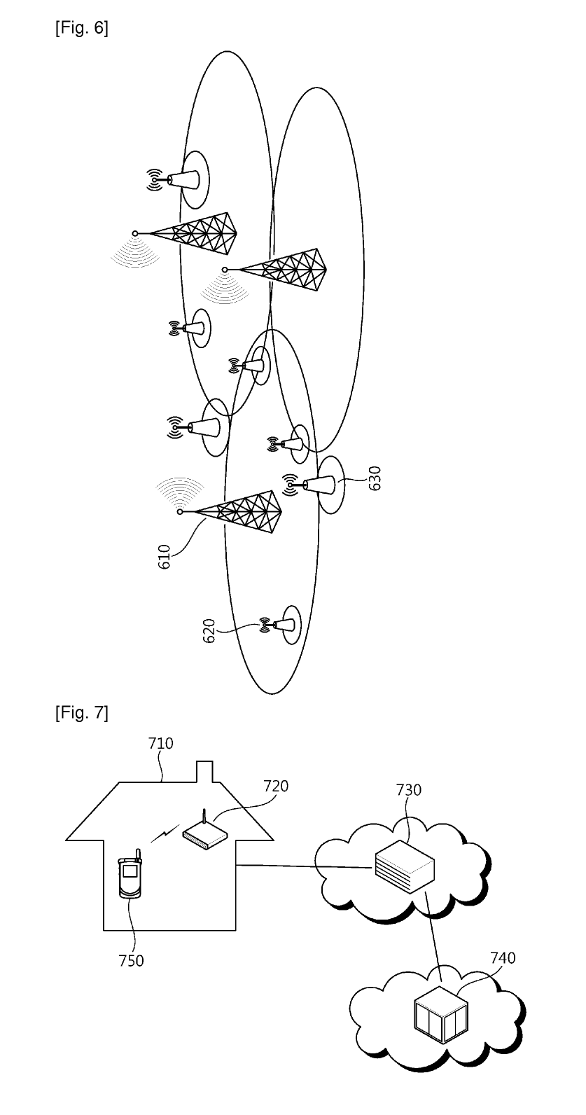

FIG. 6 is a schematic diagram illustrating a concept of a heterogeneous network consisting of a macro cell, a femto cell, and a pico cell. In FIG. 6, the heterogeneous network, consisting of the macro cell, the femto cell, and the pico cell, is described, for convenience of description, but the heterogeneous network may include a relay or other types of cells.

Referring to FIG. 6, in the heterogeneous network, a macro cell 610, a femto cell 620, and a pico cell 630 are operated together. The macro cell 610, the femto cell 620, and the pico cell 630 have respective cell coverages 610, 620, and 630. The femto cell is a low power wireless access point and is an ultra-small BS for mobile communication which is used in a room, such as a home or an office. The femto cell may access a mobile communication core network by using a DSL or cable broadband in a home or office.

FIG. 7 is a schematic conceptual diagram illustrating the configuration of the femto cell.

Referring to FIG. 7, a femto cell BS 720 within a home 710 or an office is connected to a mobile communication network 740 through an ultra-high Internet 730. UE 750 within the femto cell may access the mobile communication network or the ultra-high Internet through the BS of the femto cell 720.

Meanwhile, femto cells may support a self-organization function. The self-organization function is classified into a self-configuration function, a self-optimization function, and a self-monitoring function.

The self-configuration function is a function capable of installing a wireless BS for itself on the basis of an initial installation profile without experiencing a cell planning step. The self-optimization function is a function of identifying adjacent BSs, obtaining information from the BSs, optimizing a list of the adjacent BSs, and optimizing coverage and a communication capability according to a change of subscribers and traffic. The self-monitoring function is a function of performing control so that service performance is not deteriorated based on gathered information.

A femto cell may distinguish a registered user and an unregistered user from each other and allow access for only the registered user. A cell that allows access for only a registered user is called a Closed Subscriber Group (hereinafter referred to as a ‘CSG’), and allowing access for common users is called open access. Furthermore, the two schemes may be mixed and operated.

A BS that provides CSG service is called a Home NodeB (HNB) or a Home eNodeB (HeNB) in 3GPP. In the following specification, both the HNB and the HeNB are collectively called an HNB. An object of the HNB is to basically provide specialized service to only a member belonging to a CSG. However, service may be provided to users other than a CSG according to an operating mode set by the HNB.

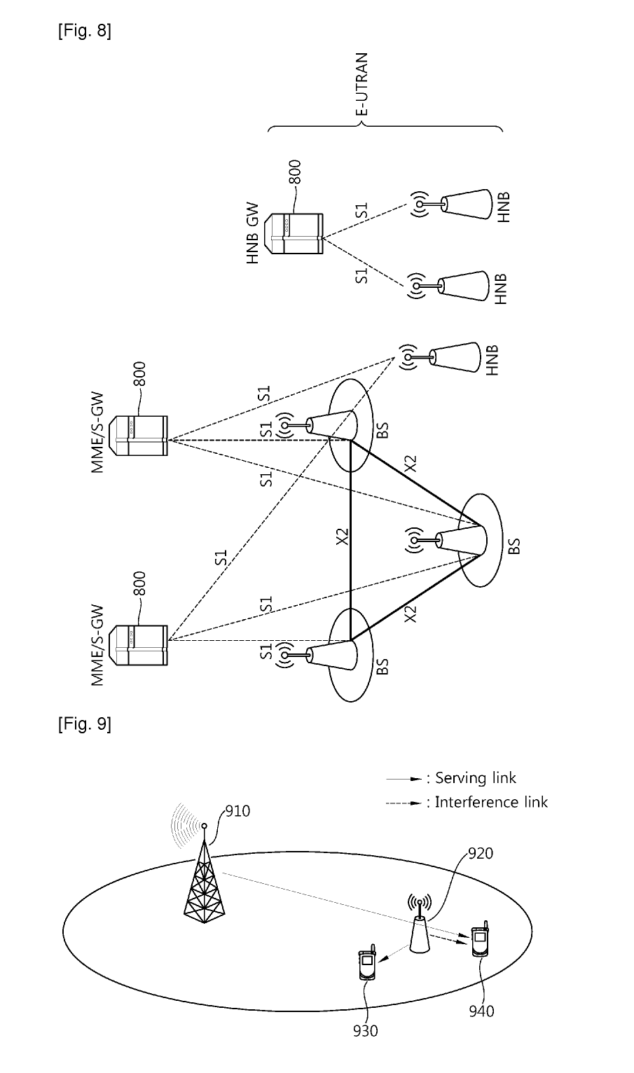

FIG. 8 is a schematic exemplary diagram of a network structure that operates an HNB using an HNB gateway (GW).

HNBs may be connected to an EPC through an HNB GW or may be directly connected to the EPC. Here, the HNB GW may look like a common BS to an MME. Furthermore, the HNB GW may look like an MME to the HNB. Accordingly, the HNB and the HNB GW are interconnected through an S1 interface, and the HNB GW and the EPC are also interconnected through the S1 interface. Furthermore, even when the HNB and the EPC are directly coupled, they are interconnected through the S1 interface. The function of the HNB is almost the same as that of a common BS.

In general, an HNB has lower wireless transmission output than a BS owned by a mobile communication network provider. Accordingly, coverage provided by the HNB is commonly smaller than a service area provided by the BS.

From a viewpoint of provided service, when an HNB provides service to only a CSG, a cell provided by the HNB is called a CSG cell. Each CSG has a unique identifier. The identifier is called a CSG identity (ID). UE may have a list of CSGs to which the UE belongs as a member. The CSG list may be changed at the request of the UE or according to a network command.

An HNB may need not to always allow access to CSG UE. Furthermore, the is access of UE which is a non-CSG member may be allowed according to the configuration setting of an HNB. What UE may be allowed for access is changed according to the configuration setting of an HNB. Here, the configuration setting refers to the setting of an operating mode of the HNB. The operating mode of the HNB is classified into three types below according to what service is provided to what UE.

1) Closed access mode: a mode where service is provided to only a specific CSG member. An HNB provides a CSG cell.

2) Open access mode: a mode where service is provided without restriction, such as a specific CSG member, like a common BS. An HNB provides a common cell (i.e., a non-CSG cell).

3) Hybrid access mode: a mode where CSG service can be provided to a specific CSG member and service can also be provided to non-CSG members as in a common cell. The common cell is recognized as a CSG cell by CSG member UE and is recognized as a common cell by non-CSG member UE. This cell is called a hybrid cell.

In a heterogeneous network in which a femto cell and a macro cell are operated together, if the mode of the femto cell is the open access mode, a user may use data service by accessing a desired one of the macro cell and the femto cell.

If the mode of the femto cell is, for example, the closed access mode, a common user using the macro cell cannot use the femto cell although the macro cell experiences interference from the femto cell that transmits a signal of a strong intensity.

Meanwhile, as shown in FIG. 8, the BSs of a macro cell are interconnected through an X2 interface. The X2 interface supports seamless and lossless handover between the BSs, maintains the balance of a network load, and supports the management of radio resources. Although the BSs of a macro cell are shown in FIG. 8, the BSs of a pico cell are also connected to the BSs of the macro cell through the X2 interface. Accordingly, if interference occurs between the macro cells, between the pico cells, or between the macro cell and the pico cell, the X2 interface functions to coordinate inter-cell interference.

On the other hand, there is no interface, such as the X2 interface, between the BS of the macro cell and the BS of a femto cell. Accordingly, dynamic signaling is not performed between the BS of the macro cell and the BS of the femto cell, like dynamic signaling between the BSs of the macro cell and the pico cell.

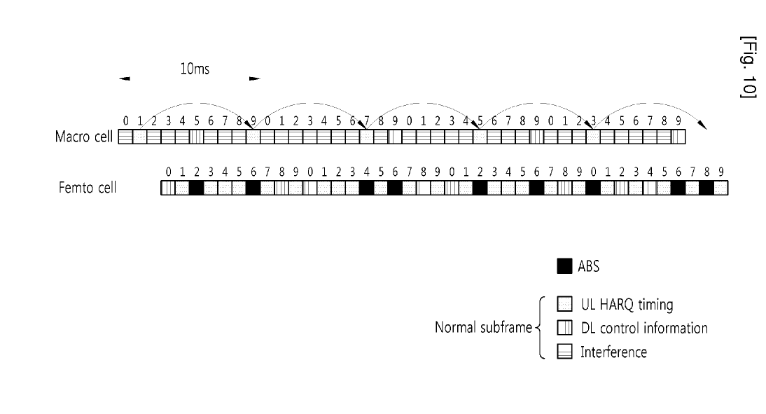

FIG. 9 is a schematic diagram illustrating that a user terminal is affected by interference between a macro cell and a femto cell in downlink.

Referring to FIG. 9, a user terminal 930 may access a femto cell 920 and use the femto cell. If the femto cell 920 is in a CSG mode and a user terminal 940 near an HNB is not a user terminal registered with a CSG, however, the user terminal 940 cannot access a femto cell having a strong signal intensity, but inevitably accesses a macro cell having a signal intensity relatively weaker than the signal intensity of the femto cell. In this case, the user terminal 940 may be affected by interference from the femto cell.

In interference between a macro cell and a femto cell (i.e., inter-cell interference), a victim cell that is further affected by interference or must be further protected from interference is the macro cell. On the other hand, an aggressor cell that gives interference to a victim cell and is less affected by interference is the femto cell. In general, interference experienced by a weak signal of a macro cell is greater than interference experienced by a signal of a strong intensity outputted from the BS of a femto cell which is near the macro cell. This is because the number of users of the macro cell is much larger than the number of users of the femto cell.

A method of reducing inter-cell interference includes Inter-Cell Interference Coordination (ICIC).

In general, ICIC is a method of supporting reliable communication for a user belonging to a victim cell when the user is near an aggressor cell. In order to coordinate inter-cell interference, for example, restrictions may be put on a scheduler regarding the use of what time or what frequency resources or both. Furthermore, restrictions may also be put on the scheduler regarding how much power will be used in what time or what frequency resources or both. In order to coordinate interference between adjacent cells, the pattern of downlink subframes of the cells may be used.

The use of the subframe pattern in the ICIC method is described below.

As described above, since there is no interface, such as the X2 interface, between the BS of the macro cell and the BS of the femto cell, it is better that the pattern of downlink subframes of the macro cell and the femto cell be static or semi-static. Here, the pattern of subframes refers to the arrangement of subframes that are repeated at specific intervals. Furthermore, the pattern of subframes may include various subframes. For example, the pattern of subframes may include the arrangement of low interference subframes less generating inter-cell interference, such as a normal subframe and an Almost Blank Subframe (ABS) which are repeated at specific intervals, as will be described later.

An LTE downlink FDD scheme in which both Frequency Division Duplex (FDD) and Time Division Duplex (TDD) are supported has a subframe pattern of 40 milliseconds (ms). An LTE downlink TDD scheme has a subframe pattern of 20 ms, 70 ms, or 60 ms according to an uplink-downlink (UL-DL) configuration.

It is to be noted that subframes forming a subframe pattern includes a subframe is that must be transferred by a BS in downlink. For example, an uplink HARQ signal, a PBCH, an PSS/SSS, an MIB, a paging message, and SIB-1 must be transferred by a BS in downlink accurately to the highest degree.

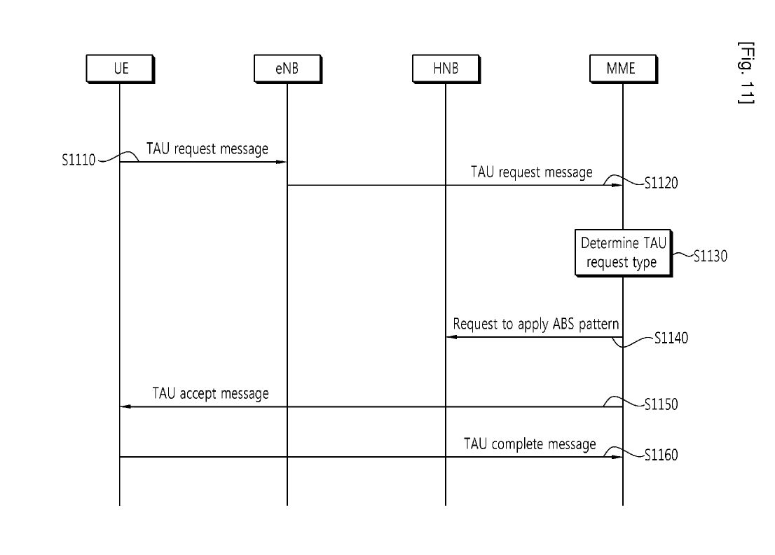

FIG. 10 is a schematic diagram showing an example of a pattern of downlink subframes of an FDD scheme in a macro cell and a femto cell. As shown in FIG. 10, the transmission of HARQ ACK/NACK signals of a BS is performed every 8 ms, and the retransmission of UE is also performed every 8 ms. Accordingly, in a subframe configuration having a unit of 40 ms, a maximum of four times of HARQ ACK/NACK signal transmission and equivalent uplink data retransmissions may be performed.

A BS must transfer the uplink HARQ signal, the PBCH, the PSS/SSS, the MIB, the paging message, and the SIB-1 in downlink accurately to the highest degree for a system operation.

A Physical Broadcast Channel (PBCH) is a physical channel that transfers basic system information which enables other channels to be configured and operated within a cell. The PBCH is transmitted through a broadcast scheme.

A Primary Synchronization Signal (PSS) and a Secondary Synchronization Signal (SSS) are signals transmitted in downlink in order to help cell search.

A System Information Block (SIB) configures system information. A Master Information Block (MIB) from the SIB is transferred on a PBCH and composed of a parameter which is essential for a cell to perform initial access and is most frequently transmitted within a limited number. A System Information Block (SIB)-1 from the SIB includes information about whether a user terminal will be positioned in a relevant cell.

A paging message is used in a network initialization connection configuration. In an idle state, UE detects an incoming call and monitors a paging channel in order to acquire system information. In order to increase reception reliability, the paging message informing a change of system information is repeatedly transmitted during the change period of a Broadcast Control Channel (BCCH) that is a logical channel on which system information from a network within a cell is transmitted all the user terminals.

Control information, such as the uplink HARQ signal, the PBCH, the PSS/SSS, the MIB, the SIB-1, and the paging message, is transmitted according to specific rules.

For example, the uplink Hybrid ARQ (HARQ) ACK/NACK signal is transmitted at an interval of 8 ms (i.e., at an interval of 8 subframes). The Physical Broadcast Channel (PBCH) is transmitted through Resource Blocks (RBs) in the 0^{th} subframe. The Primary Synchronization Signal (PSS) and the Secondary Synchronization Signal (SSS) are transmitted through RBs in the 0^{th} and 5^{th} subframes.

Furthermore, the Master Information Block (MIB) from the SIB is transmitted through RBs in the 0^{th} subframe. The System Information Block (SIB)-1 is transmitted in the 5^{th} subframe of an even-numbered frame.

Accordingly, regarding subframes on which pieces of information important for a system operation, such as the HARQ ACK/NACK signal, the PBCH, the PSS/SSS, the MIB, the SIB-1, and the paging message, are transmitted from among subframes transmitted in the downlink of a macro cell, a scheme for limiting the subframes of a femto cell, corresponding to the macro cell, to subframes capable of minimizing interference with the macro cell may be taken into consideration. As described above, in general, interference experienced by a weak signal of a macro cell is greater than interference experienced by a signal having a strong intensity outputted from a femto cell BS near the macro cell, and the number of users of the is macro cell is much larger than the number of users of the femto cell. For this reason, it is preferred that interference experienced by the macro cell be reduced to the highest degree by coordinating the configuration of subframes transmitted in the downlink of the femto cell.

An Almost Blank Subframe (ABS) may be used as a low interference subframe capable of minimizing interference with a corresponding subframe. The ABS is a subframe in which data that may not be transmitted is emptied to the highest degree and transmitted. In general, the ABS may include an MBSFN subframe.

If the subframe of a femto cell, corresponding to the subframe of a macro cell on which information necessary for a system operation is transmitted is configured as an ABS as described above, a subframe on which information to be protected is transferred, from among subframes transmitted in the downlink of the macro cell, can be protected from interference due to the femto cell.

In order to coordinate inter-cell interference, the downlink subframe pattern of a macro cell must correspond to the downlink subframe pattern of a femto cell which is configured as an ABS. To this end, the downlink subframe pattern of the macro cell may be operated statically or semi-statically based on the downlink subframe pattern of the femto cell.

In order to coordinate inter-cell interference using a subframe pattern, a pattern of an ABS forming a subframe pattern is important. A pattern of subframes in which the ABS is placed in order to coordinate inter-cell interference is hereinafter called an ABS pattern.

In a heterogeneous network, the influence of inter-cell interference is various. For example, in FIG. 9, assuming that the UE 940 near a femto cell (i.e., a CSG cell) 920 is in an RRC_IDLE state, if the UE 940 is not a CSG member, the RRC_IDLE state of the UE may continue without switching to an RRC_CONNECTED state owing to interference due to the femto cell 920.

In this case, if the femto cell 910 applies an ABS pattern, the UE of the RRC_IDLE state may switch to the RRC_CONNECTED state, if necessary, without being affected by inter-cell interference. However, an X2 interface or an S1 interface for backhaul coordination does not exist between a macro cell and the femto cell. Thus, if the macro cell UE of the RRC_IDLE state exists near the femto cell (i.e., a CSG cell), there is a need for a method in which the femto cell applies the ABS pattern so that the influence of inter-cell interference applied to the macro cell UE can be reduced.

The present invention relates to a method in which a femto cell (i.e., a CSG cell) actively utilizes an ABS pattern, if UE of an RRC_IDLE state which is not a CSG member is near the femto cell and the femto cell does not apply the ABS pattern or does not actively utilize an ABS on a subframe pattern.

In the present invention, when UE of an RRC_IDLE state which is not a CSG member is near a femto cell (i.e., a CSG cell), if the UE performs manual cell selection, an MME can request the femto cell to use an ABS pattern by using a TAU request message transmitted from the UE to the MME.

In the present invention, when UE of an RRC_IDLE state which is not a CSG member is near a femto cell (i.e., a CSG cell), if the UE performs autonomous cell search, the UE can request the femto cell to use an ABS pattern by sending an interference message to the femto cell.

A method of requesting a femto cell (i.e., a CSG cell) to use an ABS pattern when UE of an RRC_IDLE state which is not a CSG member is near the femto cell is described in detail below with reference to the drawings.

In a heterogeneous network consisting of non-CSG cells and a femto cell (i.e., a CSG cell), if UE of an RRC_IDLE state which is not a CSG member is near the femto cell (i.e., a CSG cell), the femto cell may not use an ABS pattern or may use the ABS pattern to some extent. Accordingly, the femto cell not using the ABS pattern may be requested to use the ABS pattern, and the femto cell using the ABS pattern may be requested to coordinate the application of the ABS pattern. In this specification, unless otherwise described, both the cases are meant to express “the ABS pattern is applied”, for convenience of description.

Furthermore, in a heterogeneous network consisting of non-CSG cells and a femto cell (i.e., a CSG cell), if UE of an RRC_IDLE state which is not a CSG member is near the femto cell, the UE may manually perform cell selection or may autonomously perform cell search.

FIG. 11 is a flowchart schematically illustrating an example in which UE requests a femto cell to apply an ABS pattern by manually performing cell selection in a system to which the present invention is applied.

As described above, in case of a TAU request according to manual CSG selection, the UE of an RRC_IDLE state may transmit a TAU request message to an MME through an eNB. Accordingly, the UE which is near the femto cell (i.e., a CSG cell), but is not a CSG member can transmit a TAU request message to an MME by manually selecting the femto cell. Furthermore, since the femto cell also receives signaling from the MME, the UE may request the femto cell to apply an ABS pattern through the MME.

More particularly, UE of an RRC_IDLE state transmits a TAU request message to the eNB of a macro cell on which the UE is camping by performing manual cell selection on a femto cell from which the application of an ABS pattern will be requested at step S1110. In this case, the femto cell that will be requested to apply the ABS pattern is a femto cell providing CSG service, and the UE is not a member of the relevant CSG. If the UE is a member of the relevant CSG, the UE may perform a necessary operation by camping on the femto cell or by setting up RRC connection through the BS of the femto cell without being affected by inter-cell interference. The eNB to which the UE of an RRC_IDLE state transmits the TAU request message may be an eNB of a cell that is the closest to the UE or an eNB of a cell that transmits the strongest signal, from among cells (i.e., non-CSG cells). The eNB to which the UE transmits the TAU request message may be an eNB of a macro cell, an eNB of a pico cell, or an eNB of a femto cell (i.e., a non-CSG cell). It is to be noted that the present invention may be applied to not only a heterogeneous network, but also a case where UE of an RRC_IDLE state requests a relevant cell to coordinate interference, generated by the cell to which the UE cannot directly make access, in order to coordinate the interference over a network including the same kinds of cells.

The eNB transfers the received TAU request message to the MME at step S1120. The TAU request message is information of an NAS level, and thus the eNB transfers the TAU request message to the MME which transparently manages the eNB.

The MME performs a procedure necessary for a TAU based on the received TAU request message.

The MME also determines a type of the received TAU request message at step S1130. If the TAU request message corresponds to a TAU request according to manual CSG selection, the MME might have been previously configured to request a relevant femto cell to apply an ABS pattern.

The MME receives the TAU request message and then may check whether the is relevant TAU request corresponds to a TAU request according to manual CSG selection using various methods. For example, the TAU request message may include a cause value for the relevant TAU request. The cause value is an information element transmitted to inform a reason or cause of a specific event occurred. As described above, the TAU may be requested in various cases. The cause value may be defined in each of the cases. For example, if a cause value corresponding to a case where permission is not allowed for a relevant CSG is #25, the MME may check whether the relevant TAU request corresponds to the TAU request according to manual CSG selection by decoding a TAU request message in order to check whether the cause value is #25.

If, as a result of the check, the received TAU request message corresponds to a TAU request according to manual CSG selection, the MME transmits a message, requesting to apply an ABS pattern, to the BS of a relevant femto cell at step S1140. If the femto cell is a CSG cell, the BS of the femto cell may receive a message, requesting to apply the ABS pattern, from the MME. When the request to apply the ABS pattern is received, the BS of the femto cell may apply the ABS pattern in order to coordinate inter-cell interference. That is, a femto cell not applying an ABS pattern may start applying the ABS pattern, and a femto cell already applying an ABS pattern may perform coordination, such as an increase of frequency of an ABS on a downlink subframe pattern.

The MME transmits a TAU accept message to the UE in response to the TAU request at step S1150. In response to the TAU accept message, the UE completes the TAU procedure by sending a TAU complete message to the MME at step S1160.

Meanwhile, one MME may manage both an eNB to which UE transmits a TAU and the HNB of a femto cell from which the application of an ABS pattern will be requested, or is an MME managing the eNB may be different from an MME managing the HNB of the femto cell.

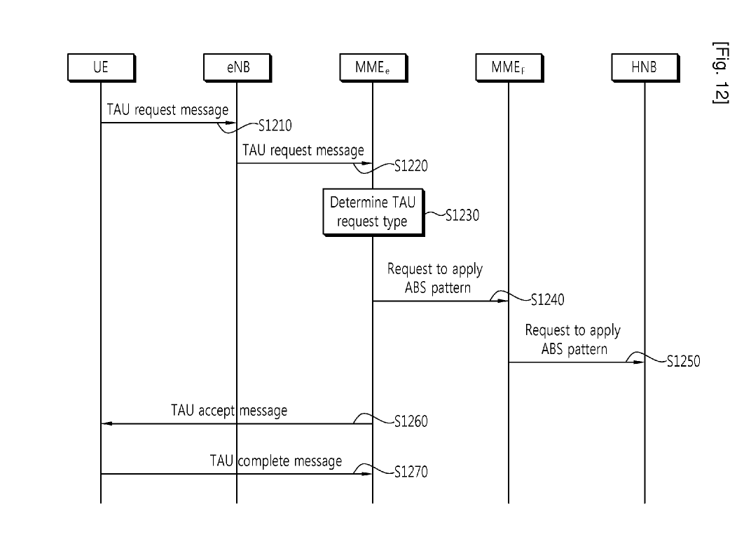

FIG. 12 is a flowchart schematically illustrating another example in which UE requests a femto cell to apply an ABS pattern by manually performing cell selection, if an MME managing an eNB to which the UE transmits a TAU is different from an MME managing an HNB of the femto cell from which the UE will request to apply an ABS pattern in a system to which the present invention is applied.

The UE of an RRC_IDLE state transmits a TAU request message to an eNB of a cell on which the UE is camping by performing manual cell selection on a femto cell that will be requested to apply an ABS pattern at step S1210. Here, the femto cell that will be requested to apply the ABS pattern is a CSG cell, and the UE is not a member of the relevant CSG. Furthermore, the eNB to which the UE transmits the TAU request message may be an eNB that is the closest to the UE of an RRC_IDLE state or an eNB of a cell that transmits the strongest signal, from among cells (i.e., non-CSG cells). The eNB to which the UE of an RRC_IDLE state transmits the TAU request message may be an eNB of a macro cell, an eNB of a pico cell, or an eNB of a femto cell which is a non-CSG cell. It is to be noted that the present invention may be applied to not only a heterogeneous network, but also a case where UE of an RRC_IDLE state requests a relevant cell to coordinate interference, generated by the cell to which the UE cannot directly make access, in order to coordinate the interference over a network consisting of the same kinds of cells.

Next, the eNB transfers the received TAU request message to an MMEₑ managing the eNB at step S1220. The TAU request message is information of an NAS level, and thus the eNB transfers the TAU request message to the MMEₑ which transparently managing the eNB.

The MMEₑ performs a procedure necessary for a TAU based on the received TAU request message.

The MMEₑ also determines a type of the received TAU request message at step S1230. If, as a result of the determination, the TAU request message corresponds to a TAU request according to manual CSG selection, the MMEₑ might have been previously configured to request a relevant femto cell to apply an ABS pattern.

The MMEₑ receives the TAU request message and then may check whether the relevant TAU request corresponds to a TAU request according to manual CSG selection using various methods. For example, the TAU request message may include a cause value for the relevant TAU request. The cause value is an information element transmitted to inform a reason or cause of a specific event occurred. For example, if a cause value corresponding to a case where permission is not allowed for a relevant CSG is #25, the MMEₑ can check whether the relevant TAU request corresponds to the TAU request according to manual CSG selection by decoding a TAU request message in order to check whether the cause value is #25.

If, as a result of the determination, the TAU request message corresponds to the TAU request according to manual CSG selection, the MMEₑ transmits a message, requesting to apply an ABS pattern, to an MME_{F} managing a BS of a relevant femto cell at step S1240.

The MME_{F} managing the BS of the femto cell transfers the message, requesting to apply the ABS pattern, to the BS of the femto cell at step S1250. When the message requesting to apply the ABS pattern is received, the BS of the femto cell may apply the ABS pattern in order to coordinate inter-cell interference. That is, a femto cell not applying an ABS pattern may start applying the ABS pattern, and a femto cell already applying an ABS pattern is may perform coordination, such as an increase of frequency of an ABS on a downlink subframe pattern.

Here, the MMEₑ transmits a TAU accept message to the UE in response to the TAU request message at step S1260. In response to the TAU accept message, the UE transmits a TAU complete message to the MMEₑ, thus completing the TAU procedure at step S1270.

Meanwhile, if UE of an RRC_IDLE state which is not a CSG member is near a femto cell (i.e., a CSG cell) in a heterogeneous network consisting of the femto cell (i.e., a CSG cell) and non-CSG cells, the UE may autonomously perform cell search. If UE does not perform manual cell selection, the UE may perform a cell (re)selection procedure through automatic cell search.

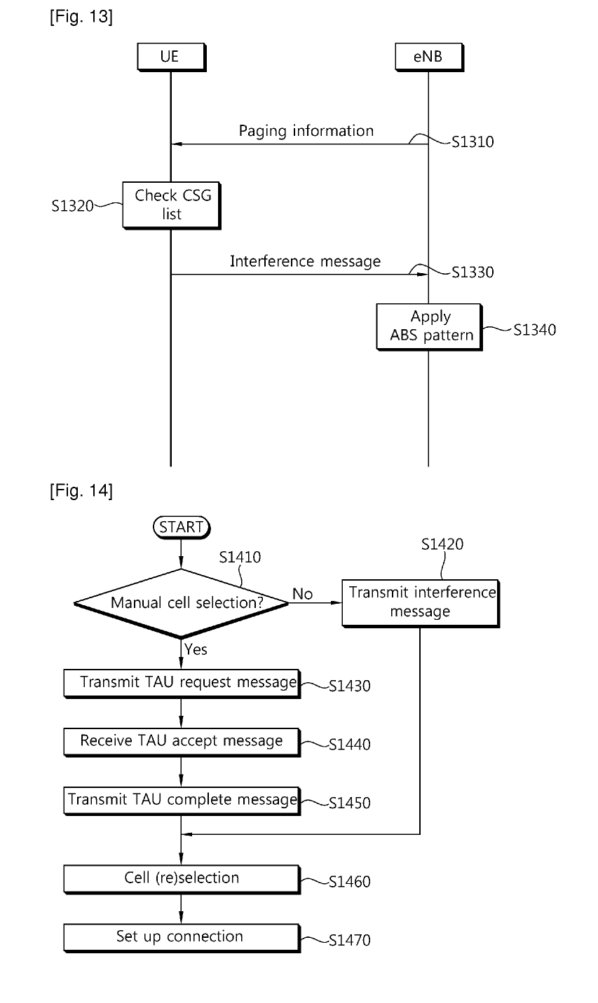

FIG. 13 is a flowchart schematically illustrating a method in which UE of an RRC_IDLE state which is near a femto cell (i.e., a CSG cell), but is not a CSG member requests the femto cell to apply an ABS pattern, if the UE autonomously performs cell search in a system to which the present invention is applied.

The UE of an RRC_IDLE state receives paging information broadcasted from the femto cell at step S1310.

The UE checks a CSG list included in the received paging information at step S1320. The UE may know whether the UE can access the femto cell by checking the CSG list.

If, as a result of the check, the UE knows that it cannot access the femto cell, the UE may transmit an interference message, such as an interference stress message, to a BS of the femto cell through a PRACH or an RACH at step S1330.

The femto cell BS that has received the interference message checks that the UE affected by inter-cell interference is near the femto cell and may coordinate the inter-cell is interference by applying an ABS pattern to downlink transmission at step S1340.

A method of performing the present invention on a subject basis in a network system is described below.

FIG. 14 is a flowchart schematically illustrating a method in which UE of an RRC_IDLE state which is not a CSG member requests an ABS pattern from a femto cell (i.e., a CSG cell) in a system to which the present invention is applied.

The UE near the femto cell (i.e., a CSG cell) determines whether to perform manual cell selection at step S1410. If, as a result of the determination, the manual cell selection is not performed, the UE may perform autonomous cell search.

The UE performing the autonomous cell search may transmit an interference message, such as an interference stress message, to the femto cell (i.e., a CSG cell) at step S1420. As will be described later, a femto cell BS that has received the interference message may start applying an ABS pattern or may take measures, such as an increase of frequency of an ABS in an ABS pattern already being applied.

If the UE determines to perform the manual cell selection, the UE selects the femto cell (i.e., a CSG cell) and transmits a TAU request message, including a TAU request according to the manual CSG selection, to an eNB at step S1430. The eNB to which the UE of an RRC_IDLE state transmits the TAU request message may be an eNB that is the closest to the UE or an eNB of a cell that transmits the strongest signal, from among cells (i.e., non-CSG cells). The eNB to which the UE transmits the TAU request message may be an eNB of a macro cell, an eNB of a pico cell, or an eNB of a femto cell (i.e., a non-CSG cell). It is to be noted that the present invention may be applied to not only a heterogeneous network, but also a case where UE of an RRC_IDLE state requests a relevant cell to coordinate interference, is generated by the cell to which the UE cannot directly make access, in order to coordinate the interference over a network including the same kinds of cells.

The TAU request message transmitted by the UE may include a cause value, indicating that the TAU request message corresponds to a TAU request according to the manual CSG selection.

The UE receives a TAU accept message, transmitted in response to the TAU request message, from an MME at step S1440. In response to the TAU accept message, the UE transmits a TAU complete message to the MME at step S1450.

The MME that has determined that the TAU request message received from the UE corresponds to the TAU request according to manual CSG selection may request the femto cell (i.e., a CSG cell) to apply the ABS pattern. When the femto cell requested to apply the ABS pattern starts applying the ABS pattern or coordinates frequency of an ABS in an ABS pattern already being applied, the UE of an RRC_IDLE state is less affected by interference due to the femto cell.

The UE of an RRC-IDLE state, less affected by interference from the femto cell, can successfully perform cell (re)selection at step S1460. For example, the UE may select a proper cell by measuring Reference Signal Received Power (RSRP) or Reference Signal Received Quality (RSRQ) for a reference signal from adjacent cells and determining the priority of cells satisfying Equation below in relation to a cell selection reception level value Sᵣₓₗₑᵥ.

Sᵣₓₗₑᵥ=Qᵣₓₗₑᵥₘₑₐₛ−(Qᵣₓₗₑᵥₘᵢₙ−Q_{rxlevminoffset})>0 dB MathFigure 1 [Math. 1]

Here, Qᵣₓₗₑᵥₘₑₐₛ is a measured cell reception level value, and RSRP may correspond to the measured cell reception level value. Furthermore, Qᵣₓₗₑᵥₘᵢₙ is a reception level that is required to a minimum limit in a relevant cell. Q_{rxlevminoffset} is an offset value for preventing a ping-pong phenomenon between Public Land Mobile Networks (PLMNs) which is generated by the fluctuation of a radio condition.

The UE of an RRC_IDLE state may camp on a (re)selected cell based on the successful cell (re)selection or sets up RRC connection (S1470).

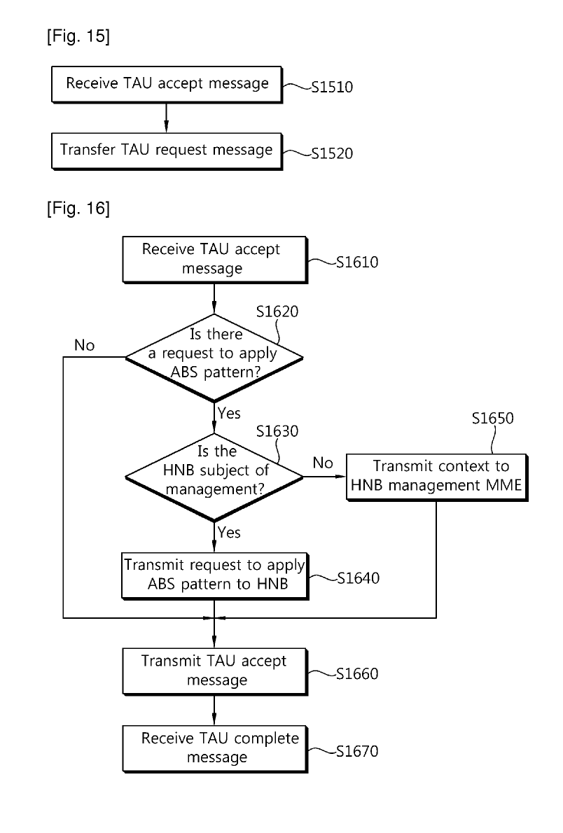

FIG. 15 is a flowchart schematically illustrating an operation performed in an eNB in case of a TAU request according to manual CSG selection in a system to which the present invention is applied.

Here, the eNB may be an eNB of a cell that is the closest to UE of an RRC_IDLE state or an eNB of a cell that transmits the strongest signal within a TA to which the UE belongs. Furthermore, the eNB may be an eNB of a macro cell, an eNB of a pico cell, or an eNB of a femto cell (i.e., a non-CSG cell). Accordingly, the present invention may be applied to not only a heterogeneous network, but also a case where UE of an RRC_IDLE state requests a relevant cell to coordinate interference, generated by the cell to which the UE cannot directly make access, in order to coordinate the interference over a network including the same kinds of cells.

If the UE selects a femto cell (i.e., a CSG) having a CSG ID not belonging to the allowed CSG list of the UE through manual CSG selection, the eNB receives a TAU request message from the UE at step S1510.

The eNB transfers the received TAU request message to an MME which manages the eNB at step S1520. The TAU request message is information of an NAS level, and thus the eNB functions to transmit the TAU request message to the MME without checking the contents of the TAU request message.

FIG. 16 is a flowchart schematically illustrating an operation performed in an MME in case of a TAU request according to manual CSG selection in a system to which the present invention is applied.

The MME receives a TAU request message from an eNB at step S1610. The MME can perform a procedure necessary for a TAU based on the received TAU request message.

The MME determines whether there is a request to apply an ABS pattern through the received TAU request message at step S1620. The MME also determines a type of the received TAU request message. If, as a result of the determination, the TAU request message corresponds to a TAU request according to manual CSG selection, the MME may determine that there is a request to apply the ABS pattern from the UE. Here, the MME may determine whether the TAU request message corresponds to the TAU request according to manual CSG selection using various methods. For example, the TAU request message may include a cause value for the relevant TAU request. The cause value is an information element transmitted to inform a reason or cause of a specific event occurred. For example, if a cause value corresponding to a case where permission is not allowed for a relevant CSG is #25, the MME may check whether the TAU request message corresponds to the TAU request according to manual CSG selection by decoding the TAU request message in order to check whether the cause value is #25.

If, as a result of the determination, there is a request to apply the ABS pattern from the UE, the MME determines whether a BS of a femto cell (i.e., the subject that will be requested to apply the ABS pattern) is the subject that is managed by the MME at step S1630.

If, as a result of the determination, the BS of the femto cell is the subject managed by the MME, the MME transmits a message, requesting to apply the ABS pattern, to the BS of the femto cell at step S1640.

If, as a result of the determination, the BS of the femto cell is not the subject managed by the MME, the MME transmits content regarding a request for the application of the ABS pattern to an MME which manages the BS of the femto cell at step S1650. The content regarding the request for the application of the ABS pattern may be a message to simply request the femto cell to apply the ABS pattern. Furthermore, the context regarding the request for the application of the ABS pattern may further include pieces of information necessary to request the femto cell to apply the ABS pattern. The MME that has received the context regarding the request for the application of the ABS pattern transmits a message, requesting to apply the ABS pattern, to the BS of the femto cell.

The BS of the femto cell that has been requested to apply the ABS pattern from the MME managing the BS may start applying the ABS pattern or may coordinate frequency of an ABS in an ABS pattern already being applied. Accordingly, the UE of an RRC_IDLE state which has requested to apply the ABS pattern can be out of the influence of interference due to the femto cell or can be less affected by interference due to the femto cell.

The MME performs a procedure regarding the TAU and transmits a TAU accept message to the UE at step S1660. Even when the request for the application of the ABS pattern is determined not to exist at step S1620, the MME performs the procedure regarding the TAU and also transmits the TAU accept message to the UE.

The MME receives a TAU complete message from the UE as a response to the TAU accept message at step S1670.

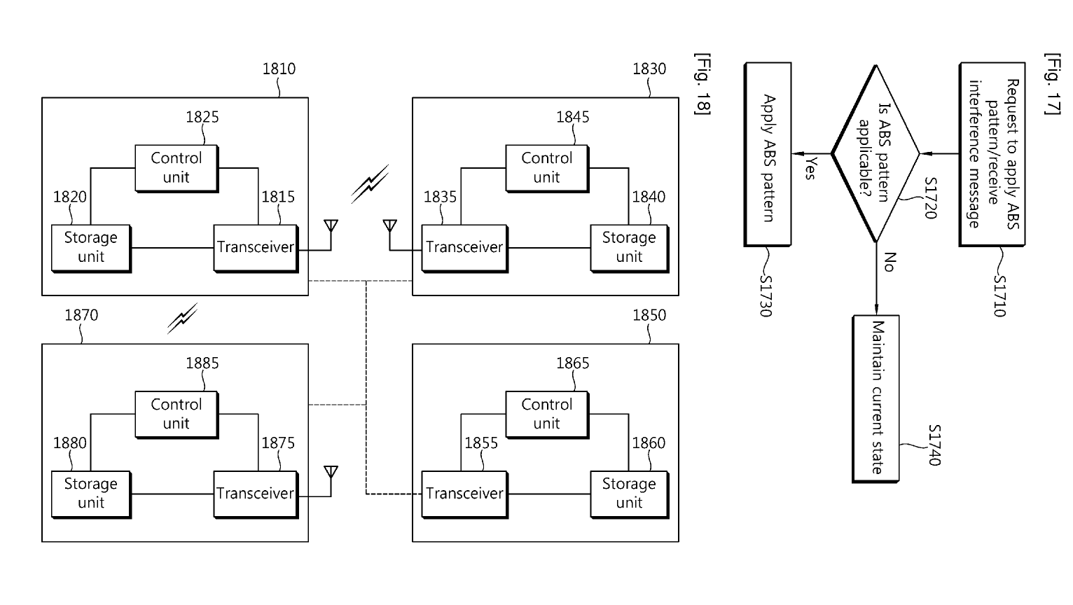

FIG. 17 is a flowchart schematically illustrating the operation of a femto cell BS that has been requested to apply an ABS pattern in a system to which the present invention is applied.

The BS of the femto cell (i.e., a CSG cell) may receive an interference message, such as an interference stress message, from UE of an RRC_IDLE state which is not a CSG member or receive a request for the application of the ABS pattern from an MME at step S1710. The BS of the femto cell may apply the ABS pattern even when an interference message is received from the UE.

The BS of the femto cell determines whether it is possible to apply the ABS pattern at step S1720. Whether it is possible to apply the ABS pattern includes whether it is possible to start applying the ABS pattern in the state where the ABS pattern has not been applied and whether it is possible to perform coordination for increasing frequency of an ABS in the state where the ABS pattern has already been applied. Accordingly, even when the femto cell (i.e., a CSG cell) already applies the ABS pattern, the UE can reduce the influence of interference by requesting the femto cell to apply the ABS pattern.

If, as a result of the determination, it is possible to apply the ABS pattern, the BS of the femto cell applies the ABS pattern at step S1730. The application of the ABS pattern includes not only starting to apply the ABS pattern, but also performing coordination for increasing frequency of an ABS in the state where the ABS pattern has already been applied.

If, as a result of the determination, it is impossible to apply the ABS pattern, the BS of the femto cell maintains a current state at step S1740. Here, the case where the application of the ABS pattern is impossible includes a case where coordination for increasing frequency of an ABS is impossible although the ABS pattern is already applied.

FIG. 18 is a schematic block diagram showing the constructions of execution entities in a system to which the present invention is applied.

UE 1810 includes a transceiver 1815, a storage unit 1820, and a control unit 1825. The UE 1810 may transmit and receive necessary information through the transceiver 1815. The UE 1810 may transmit a TAU request message to an eNB 1830 or receive a TAU accept message from an MME 1850 and transmit a TAU complete message to the MME 1850 or transmit an interference message, such as an interference stress message, to a BS 1870 of a femto cell, through the transceiver 1815. The storage unit 1820 may store information necessary for the UE 1810 to perform communication over a network. For example, the storage unit 1820 may store a CSG list obtained through paging information, a Tracking Area Identity (TAI) for identifying each TA, a cause value to be included in the TAU request message and transmitted, etc. The control unit 1825 is connected to the transceiver 1815 and the storage unit 1820 and is configured to control the transceiver 1815 and the storage unit 1820. The control unit 1825 configures a TAU request message and transmits the configured TAU request message to the eNB 1830 through the transceiver 1815. In this case, the control unit 1825 may select a cause value corresponding to a case where the TAU request message is transmitted and may include the selected cause value in the TAU request message. Furthermore, the control unit 1825 may receive a TAU accept message from the MME 1850 through the transceiver 1815, configure a TAU complete message in response to the TAU accept message, and transmit the configured TAU complete message through the transceiver 1815. The control unit 1825 may configure an interference message, such as an interference stress message, and transmit the interference message to the BS 1870 of the femto cell through the transceiver 1815. Furthermore, in an RRC_IDLE state, the control unit 1825 may be connected to the transceiver 1815 and the storage unit 1820 and configured to control the cell reselection of the UE and a procedure of setting up RRC connection.

The eNB 1830 includes a transceiver 1835, a storage unit 1840, and a control unit 1845. In the present invention, the eNB 1830 functions to transfer a TAU request message, received from the UE 1810, to the MME 1850. The eNB 1830 may be an eNB that is the closest to the UE 1810 or an eNB of a cell that transmits the strongest signal within a TA to which the UE 1810 belongs. Furthermore, the eNB 1830 may be an eNB of a macro cell, an eNB of a pico cell, or an eNB of a femto cell (i.e., a non-CSG cell). The eNB 1830 transfers the TAU request message, received from the UE 1810, to the MME 1850 through the transceiver 1835. The storage unit 1840 may store information necessary for the eNB 1830 to perform communication over a network. For example, the storage unit 1840 may store information necessary for a system operation. The control unit 1845 may be connected to the transceiver 1835 and the storage unit 1840 and configured to control the transceiver 1835 and the storage unit 1840 and transmit paging information, including system information, through the transceiver 1835.

The MME 1850 includes a transceiver 1855, a storage unit 1860, and a control unit 1865. The MME 1850 may perform transmission and reception to and from the UE 1810, the eNB 1830, and the BS 1870 of the femto cell through the transceiver 1855. The storage unit 1860 may store information necessary for the MME 1850 to operate a network and manage BSs. For example, the storage unit 1860 may store a list of BSs to be managed, information for processing a TAU request, information for identifying a cause value included in a TAU request message and transmitted, TAI information for identifying a TA, and so on. The control unit 1865 may be connected to the transceiver 1855 and the storage unit 1860 and configured to control the transceiver 1855 and the storage unit 1860. In the present invention, the control unit 1865 may determine a type of a TAU request received through a cause value, etc. Furthermore, if the received TAU request is determined to correspond to a TAU request according to manual CSG selection, the control unit 1865 may transmit a request for the application of an ABS pattern to the BS 1870 of the femto cell through the transceiver 1855. Furthermore, the control unit 1865 may transmit a TAU accept message to the UE 1810 and receive a TAU complete message in response thereto through the transceiver 1855.

The BS 1870 of the femto cell includes a transceiver 1875, a storage unit 1880, and a control unit 1885. The BS 1870 of the femto cell may receive an interference message from the UE 1810 and receive a request for the application of an ABS pattern from the MME 1850 through the transceiver 1875. The storage unit 1880 may store information necessary for the BS 1870 of the femto cell to perform communication over a network. For example, the storage unit 1880 may store information, such as a CSG ID for operating a CSG, etc. and store information necessary to autonomously apply an ABS pattern. The control unit 1885 may be connected to the transceiver 1875 and the storage unit 1880 and configured to control the transceiver 1875 and the storage unit 1880. In the present invention, the control unit 1885 may receive an interference message, such as an interference stress message, from the UE 1810. If the application of an ABS pattern is determined to be possible when a request for the application of the ABS pattern is received from the MME 1850, the control unit 1885 may start applying the ABS pattern to downlink transmission through the transceiver 1875 or increase frequency of an ABS in an ABS pattern already applied.

An example in which an ABS pattern is applied has been described as one ICIC method in the present invention, but the present invention is not limited thereto. It is to be noted that the present invention may be applied to a variety of Inter-Cell Interference Coordination (ICIC) methods which can reduce the influence of inter-cell interference due to a femto cell (i.e., a CSG cell) on UE of an RRC_IDLE state which is not a CSG member.

In the above-described exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and other steps may be included or one or more steps of the flowcharts may be deleted without affecting the scope of the present invention.

The above-described embodiments include various aspects of examples. Although all possible combinations for describing the various aspects may not be described, those skilled in the art may appreciate that other combinations are possible. Accordingly, the present invention should be construed to include all other replacements, modifications, and changes which fall within the scope of the claims.

1. A method of User Equipment (UE) of an RRC_IDLE state requesting Inter-Cell Interference Coordination (ICIC), the method comprising the steps of:
selecting a Closed Subscriber Group (CSG) femto cell having a CSG Identity (ID) not included in an allowed CSG list; and
transmitting a Tracking Area Update (TAU) request message to a Mobility Management Entity (MME), managing a Base Station (BS), through the BS,
wherein the TAU request message comprises a transfer request message requesting that a request to apply the ICIC be transferred to the BS of the CSG femto cell.

2. The method of claim 1, wherein the transfer request message is a cause value indicating that the TAU request message is transmitted by selecting the CSG femto cell having the CSG ID not included in the allowed CSG list.

3. The method of claim 1, wherein the ICIC is an application of an Almost Blank Subframe (ABS) pattern.

4. The method of claim 1, further comprising the step of determining whether to perform manual cell selection or autonomous cell search, wherein if the manual cell selection is determined to be performed, the steps from the step of selecting the CSG femto cell are performed, and if the autonomous cell search is determined to be performed, a message requesting to apply an ABS pattern is directly transmitted to the CSG femto cell.

5. The method of claim 4, wherein the message requesting to apply the ABS pattern is an interference stress message transmitted on a random access channel.

6. A method of a Mobility Management Entity (MME) processing a request for Inter-Cell Interference Coordination (ICIC), the method comprising:
receiving a Tracking Area Update (TAU) request message;
determining whether a transfer request message, requesting that a request to apply Inter-Cell Interference Coordination (ICIC) be transferred to a Base Station (BS) of a CSG femto cell, is included in the TAU request message; and
if the transfer request message is determined to be included in the TAU request message, transmitting a request to apply the ICIC to the BS of the CSG femto cell.

7. The method of claim 6, wherein if the TAU request message is de-termined to be a TAU request message received from User Equipment (UE) when the UE selects a CSG femto cell having a CSG ID not included in an allowed CSG list, the transfer request message is de-termined to be included in the TAU request message.

8. The method of claim 7, wherein whether the TAU request message is the TAU request message received from the UE when the UE selects the CSG femto cell having the CSG ID not included in the allowed CSG list is determined by checking a cause value for a TAU request.

9. The method of claim 6, wherein if the CSG femto cell is not a subject of management, a message requesting that the request to apply the ICIC be transferred to the BS of the CSG femto cell is transmitted to an MME managing the BS of the CSG femto cell.

10. A method of a Closed Subscriber Group (CSG) femto cell processing a request for Inter-Cell Interference Coordination (ICIC), the method comprising:
receiving a request to apply an Almost Blank Subframe (ABS) pattern for the ICIC from a Mobility Management Entity (MME) or receiving a message, informing that User Equipment (UE) which is not a CSG member is affected by interference from, the UE; and
applying the ABS pattern for the ICIC based on the request or the message,
wherein if the ABS pattern is being applied, frequency of an ABS in the ABS pattern is increased.

11. A user equipment, comprising:
a transceiver configured to transmit and receive information;
a storage unit configured to store information necessary to perform communication; and
a control unit coupled to the transceiver and the storage unit and configured to control the transceiver and the storage unit,
wherein the control unit selects a Closed Subscriber Group (CSG) femto cell having a CSG ID not included in an allowed CSG list in an RRC_IDLE mode, configures a Tracking Area Update (TAU) request message corresponding to the selected CSG femto cell, and transmits the TAU request message through the transceiver, and
the TAU request message comprises a transfer request message requesting that a request to apply Inter-Cell Interference Coordination (ICIC) be transferred to a base station of the CSG femto cell.
